(19) United States
(12) Patent Application Publication
(10) Pub. No.: US 2024/0152363 A1
(43) Pub. Date: May 9, 2024

(54) MANAGEMENT DEVICE, COMMUNICATION SYSTEM, MANAGEMENT METHOD, AND NON-TRANSITORY COMPUTER-READABLE MEDIUM

(71) Applicant: NEC Corportion, Minato-ku, Tokyo (JP)

(72) Inventor: Ryota KUBONIWA, Tokyo (JP)

(73) Assignee: NEC Corportion, Minato-ku, Tokyo (JP)

(21) Appl. No.: 18/281,408

(22) PCT Filed: Mar. 14, 2022
(86) PCT No.: PCT/JP2022/011287

§ 371 Date: Sep. 11, 2023

(30) Foreign Application Priority Data
Mar. 19, 2021 (JP) 2021-045744

(51) Int. Cl. G06F 9/445

(52) U.S. Cl. CPC G06F 9/44505

(57) ABSTRACT

An object is to provide a management device that can appropriately manage a code that may be applied to a plurality of systems. A management device (10) according to the present disclosure includes: an extraction unit (11) that extracts a parameter associated with definition information included in configuration information used for constructing an infrastructure system on a cloud infrastructure; and a management unit (12) that manages, when the configuration information is applied to a plurality of the infrastructure systems, the parameter to be changed according to the infrastructure system in association with the infrastructure system to which the configuration information is applied.

### TECHNICAL FIELD

The present disclosure relates to a management device, a communication system, a management method, and a program.

### BACKGROUND ART

In recent years, there has been an increase in the number of business operators that construct a system by utilizing network resources provided by a cloud provider. A business operator who performs system construction constructs a system for providing an application or a service by utilizing the provided network resources. As a method for constructing a system, a method called infrastructure as code (IaC) is known. In IaC, system elements constituting a system are defined using a source code called IaC code.

Patent Literature 1 discloses an IaC parameter update method for updating IaC parameter information included in the IaC code so as to be consistent with parameter information necessary for system construction.

### CITATION LIST

### Patent Literature

Patent Literature 1: Japanese Unexamined Patent Application Publication No. 2020-061019

### SUMMARY OF INVENTION

### Technical Problem

Patent Literature 1 discloses updating and managing the IaC code and IaC parameters applied to one target system. In general, when a business operator applies an IaC code to a system in a commercial environment in which service is provided, normality of the IaC code is verified in a system in a development environment simulating the system in the commercial environment. However, Patent Literature 1 only discloses a method for managing the IaC code applied to one target system, and there is a problem that the IaC code cannot be appropriately managed in consideration of a system in a commercial environment and a system in a development environment.

An object of the present disclosure is to provide a management device, a communication system, a management method, and a program that are capable of appropriately managing a code that may be applied to a plurality of systems.

### Solution to Problem

A management device according to a first aspect of the present disclosure includes: an extraction unit that extracts a parameter associated with definition information included in configuration information used for constructing an infrastructure system on a cloud infrastructure; and a management unit that manages, when the configuration information is applied to a plurality of the infrastructure systems, the parameter to be changed according to the infrastructure system in association with the infrastructure system to which the configuration information is applied.

A communication system according to a second aspect of the present disclosure includes: a management device including an extraction unit that extracts a parameter associated with definition information included in configuration information used for constructing an infrastructure system on a cloud infrastructure, and a management unit that manages, when the configuration information is applied to a plurality of the infrastructure systems, the parameter to be changed according to the infrastructure system in association with the infrastructure system to which the configuration information is applied; and a database that manages the configuration information.

A management method according to a third aspect of the present disclosure includes: extracting a parameter associated with definition information included in configuration information used for constructing an infrastructure system on a cloud infrastructure; and managing, when the configuration information is applied to a plurality of the infrastructure systems, the parameter to be changed according to the infrastructure system in association with the infrastructure system to which the configuration information is applied.

A program according to a fourth aspect of the present disclosure causes a computer to perform: extracting a parameter associated with definition information included in configuration information used for constructing an infrastructure system on a cloud infrastructure; and managing, when the configuration information is applied to a plurality of the infrastructure systems, the parameter to be changed according to the infrastructure system in association with the infrastructure system to which the configuration information is applied.

### Advantageous Effects of Invention

According to the present disclosure, it is possible to provide a provide a management device, a communication system, a management method, and a program that are capable of appropriately managing a code that may be applied to a plurality of systems.

### BRIEF DESCRIPTION OF DRAWINGS

FIG. 1 is a configuration diagram of a management device according to a first example embodiment.

FIG. 2 is a configuration diagram of a communication system according to a second example embodiment.

FIG. 3 is a configuration diagram of a management device according to the second example embodiment.

FIG. 4 illustrates an example of a declarative IaC code according to the second example embodiment.

FIG. 5 is a diagram illustrating an IaC code management database according to the second example embodiment.

FIG. 6 is a diagram illustrating a parameter management database according to the second example embodiment.

FIG. 7 is a diagram illustrating a change history database according to the second example embodiment.

FIG. 8 is a diagram illustrating a flow of parameter management processing according to the second example embodiment.

FIG. 9 is a diagram illustrating a flow of parameter value change processing according to the second example embodiment.

FIG. 10 is a configuration diagram of a management device according to each example embodiment.

### EXAMPLE EMBODIMENTS

### First Example Embodiment

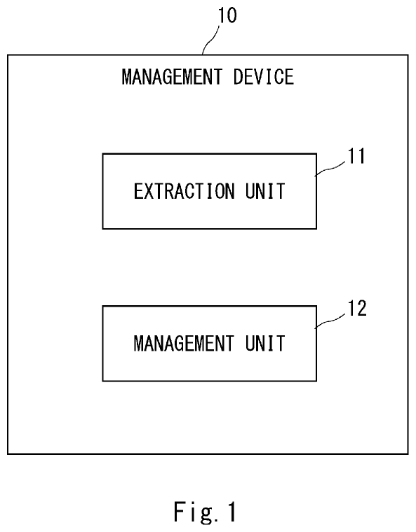

Hereinafter, example embodiments of the present invention will be described with reference to the drawings. A configuration example of a management device 10 according to a first example embodiment will be described with reference to FIG. 1. The management device 10 may be a computer device that operates when a processor executes a program stored in a memory. For example, the management device 10 may be a server device.

The management device 10 includes an extraction unit 11 and a management unit 12. The extraction unit 11 and the management unit 12 may be software components or modules whose processing is carried out by causing the processor to execute the program stored in the memory. Alternatively, the extraction unit 11 and the management unit 12 may be hardware components such as circuits or chips.

The extraction unit 11 extracts parameters associated with definition information included in configuration information. The configuration information is used to construct an infrastructure system on a cloud infrastructure. The cloud infrastructure is a network or system for implementing cloud computing. For example, a cloud provider provides a cloud infrastructure. The cloud infrastructure may be a combination of a plurality of hardware elements, a combination of plurality of software elements, or a combination of hardware elements and software elements.

The infrastructure system is a service providing system that provides a plurality of services via a network, a business system in a company, or the like, for example. A business operator or the like who is a user of the cloud infrastructure is provided with resources from the cloud provider, and implements various services by utilizing the provided resources.

The infrastructure system includes a plurality of system elements. The system elements are elements constituting the infrastructure system. The system elements include a server, a network device, a storage device, a service function, and the like, for example. The server may be a physical server device or a virtual server on which an operating system (OS) and middleware operate. The network device and the storage device may also be physical devices or virtual devices. The service function refers to a function provided by middleware, an application program, or the like, and may be simply referred to as “function” hereinafter.

The virtual server or the virtual device may be a function, software, or process that operates on virtual software installed in a physical device. The virtual software may virtualize hardware resources to cause a plurality of virtual servers or virtual devices to share the hardware resources. The plurality of virtual servers or virtual devices may operate on a common virtual OS or may operate on different virtual OSs. Alternatively, a plurality of virtual servers or virtual devices may operate on an OS mounted on a physical device and may not use a virtual OS.

The configuration information may be a program that defines system elements constituting the infrastructure system. The program is defined using code or source code. The configuration information may include parameters referred to by the program. The parameters may be defined in configuration information, a configuration file, or the like, for example. Setting the configuration information in the resources provided on the cloud infrastructure makes it possible to provide a service via the infrastructure system.

The definition information is information indicating specific parameters in the program, and is information added to the parameters. The definition information is used as a mark for extracting or specifying parameters. As the definition information, prefixes added to parameters that are variables may be used.

If the configuration information is applied to a plurality of infrastructure systems, the management unit 12 manages parameters to be changed according to the infrastructure systems in association with the infrastructure systems to which the configuration information is applied.

The case where the configuration information is applied to a plurality of infrastructure systems may be a case where a common program is applied to a plurality of infrastructure systems. For example, the plurality of infrastructure systems may be a system in a commercial environment used by a business operator to provide services (hereinafter, called a commercial system) and a system in a development environment used to develop or verify a program applied to the commercial system (hereinafter, called development system). Alternatively, the plurality of infrastructure systems may be infrastructure systems that are constructed in a plurality of areas divided by a business operator to implement the same service in the plurality of areas.

In order to apply the program verified in the development system to the commercial system, the program applied to the commercial system and the development system is basically common. However, a commercial system generally has a larger network size than a development system. That is, the commercial system generally has more resources than the development system. Therefore, the parameters set in the commercial system may be different from the parameters set in the development system. That is, the parameters are changed according to the applied infrastructure system.

For example, the management unit 12 manages parameters set to the commercial system and parameters set to the development system in a common program applied to the commercial system and the development system.

As described above, the management device 10 manages the parameters included in the configuration information commonly applied to the plurality of infrastructure systems for each applied infrastructure system. As a result, the parameters applied to each infrastructure system are clarified, and the configuration information commonly applied to the plurality of infrastructure systems can be appropriately managed.

### Second Example Embodiment

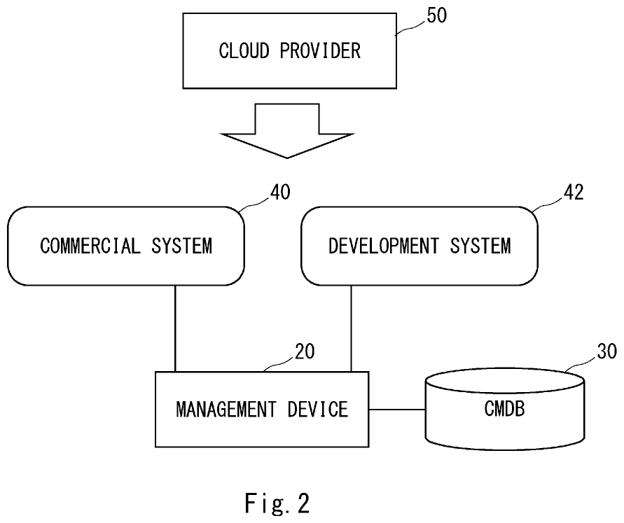

Next, a configuration example of a communication system according to a second example embodiment will be described with reference to FIG. 2. The communication system in FIG. 2 includes a management device 20, a configuration management database (CMDB) 30, a commercial system 40, and a development system 42. The commercial system 40 and the development system 42 are cloud infrastructures provided by a cloud provider 50. Alternatively, the development system 42 may not be a cloud infrastructure, but may be a system that simulates the commercial system 40, which is constructed by a business operator that manages the commercial system 40. Simulating the commercial system 40 may mean that constructing a system such that services, functions, or the like that can be provided are similar to those of the commercial system 40, and the system scale or resources are smaller than those of the commercial system 40. The management device 20 manages parameters set to the commercial system 40 and the development system 42.

The commercial system 40 and the development system 42 are constructed by combining a plurality of system elements. The combination of the plurality of system elements may be a combination of physical devices or a combination of virtual devices operating as software. Alternatively, the combination of the plurality of system elements may be a combination of a physical device and a virtual device.

Next, the CMDB 30 will be described. The CMDB 30 is a database that holds configuration information set to the commercial system 40 and the development system 42. The term storing may be replaced with memorizing, recording, registering, or the like. For example, a developer who has designed configuration information based on a design document, a required specification document, or the like registers the configuration information in the CMDB 30. Alternatively, the developer may update the configuration information stored in the CMDB 30. An operator who applies configuration information to the commercial system 40 applies the configuration information stored in the CMDB 30 to the commercial system 40. The developer or the operator may register the configuration information in the CMDB 30 or extract the configuration information from the CMDB 30 via a network using a computer device. For example, an IaC code and parameters referred to in the IaC code may be registered in the CMDB 30 as configuration information. The CMDB 30 may manage the IaC code applied for each environment, that is, for each infrastructure system.

The CMDB 30 may manage not only the latest configuration information but also a plurality of generations of configuration information identified by a history or a version. For example, the developer may store new configuration information in the CMDB 30 in distinction from configuration information of old generations. As the CMDB 30 manages a plurality of generations of configuration information, if a failure occurs by applying the latest configuration information to the commercial system 40, the operator can also apply old configuration information that has been normally operating to the commercial system 40, for example.

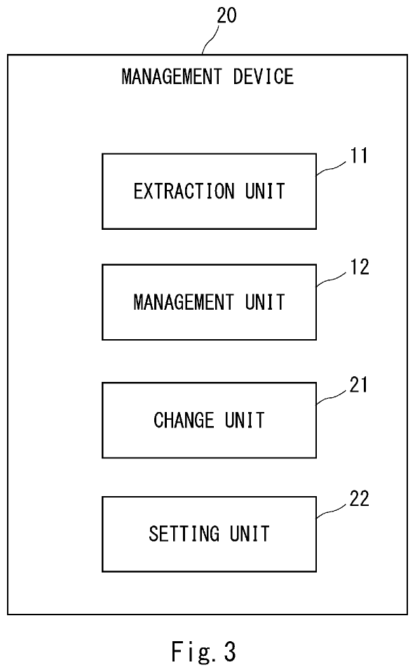

Next, a configuration example of the management device 20 according to the second example embodiment will be described with reference to FIG. 3. The management device 20 has a configuration in which a change unit 21 and a setting unit 22 are added to the management device 10 in FIG. 1. The change unit 21 and the setting unit 22 may be software components or modules whose processing is carried out by causing the processor to execute the program stored in the memory. Alternatively, the change unit 21 and the setting unit 22 may be hardware components such as circuits or chips. Since an extraction unit 11 and a management unit 12 are similar to those in the management device 10 in FIG. 1, differences from the management device 10 in FIG. 1 will be mainly described below.

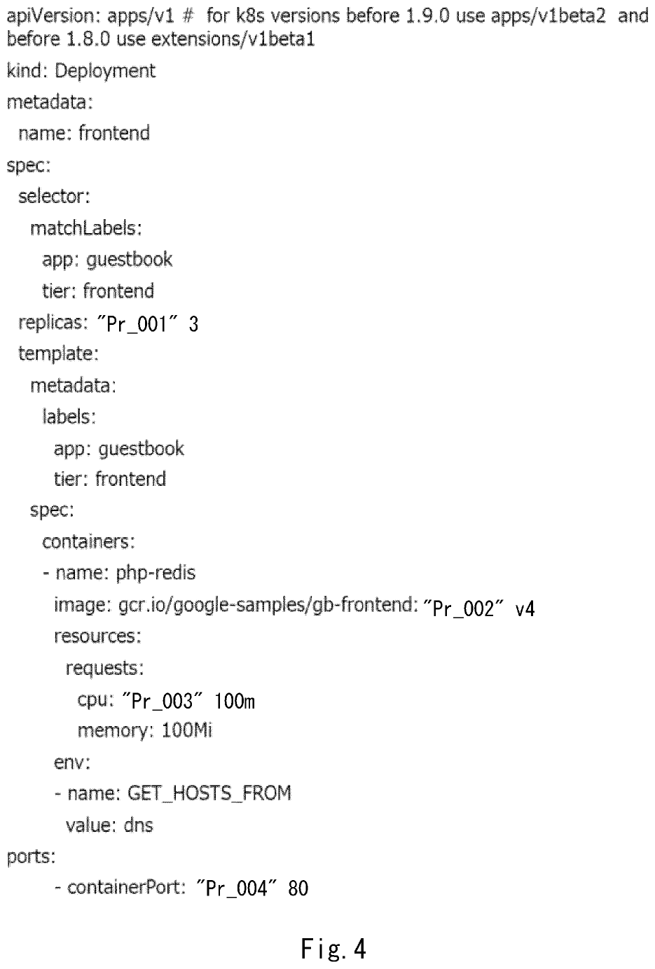

An example of configuration information used by the extraction unit 11 to extract parameters associated with definition information will be described with reference to FIG. 4. FIG. 4 illustrates an example of a declarative IaC code (hereinafter referred to as IaC code) defining a program. FIG. 4 illustrates the IaC code that defines an infrastructure system as a virtual system using a container. A container is an area that operates on a container engine. For example, the container may be an application execution environment built on a host OS common to a plurality of containers.

Pr_001 to Pr_004 included in the IaC code in FIG. 4 indicate prefixes which are definition information. For example, Pr_001 indicates the number of containers included in the infrastructure system. Pr_002 indicates a container version applied to the container. Pr_003 indicates a resource used for the container. Pr_004 indicates a port number.

When generating the IaC code, the developer may add or associate a prefix with a parameter having different values between the commercial system and the development system. For example, as for the number of containers, the number of containers in the commercial system may be greater than the number of containers in the development system. As for the container version, the latest version of containers may be used in the development system, and an old version of containers may be used in the commercial system. As for resources, the commercial system may use more resources than the development system. As for port setting, the required system and the development system may use different port numbers.

FIG. 4 illustrates an example of a source code in which a prefix is added to a parameter. On the other hand, for example, the prefix may be used as a variable in the source code, and the prefix as a variable may refer to a parameter defined in a configuration file or the like.

The extraction unit 11 acquires the IaC code from the CMDB 30, and extracts a parameter associated with a prefix in the acquired IaC code. The parameter extracted by the extraction unit 11 is managed by the management unit 12.

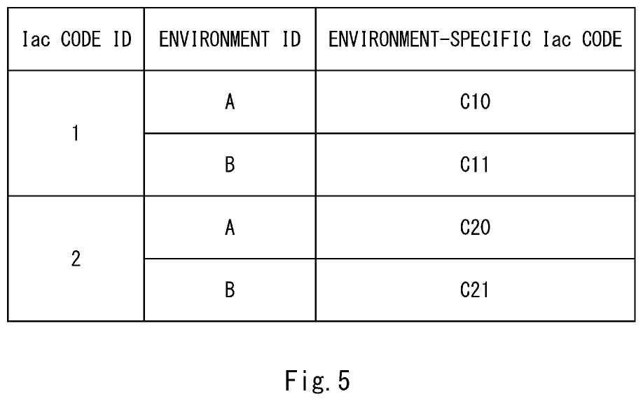

Data managed by the management unit 12 will be described with reference to FIGS. 5 to 7. FIG. 5 shows an IaC code management database. The IaC code management database manages IaC code IDs, environment IDs, and environment-specific IaC codes in association with one another. The IaC code ID indicates identification information of the IaC code commonly applied to the commercial system and the development system. The environment ID indicates identification information of an environment to which the IaC code indicated by the IaC code ID is applied. For example, environment ID_A may indicate the commercial system, and environment ID_B may indicate the development system. The environment-specific IaC code indicates an IaC code identified by the IaC code ID in which the values of parameters are adjusted for each applied environment. An environment-specific IaC code_C10 is applied to the commercial system, and an environment-specific IaC code_C11 is applied to the development system. The IaC code_C10 is similar to the IaC code_C11 except for parameters having different values among applied environments.

FIG. 6 illustrates a parameter management database. The parameter management database manages IaC code IDs, prefixes, environment IDs, and parameter values in association with one another. The prefix refers to a prefix included in the IaC code identified by the IaC code ID. The parameter value refers to a value set to the prefix-added parameter. The parameter value may be a number or a character string. FIG. 6 illustrates that the values set to the prefix-added parameters are different for each environment. For example, as for prefix 001, a parameter value_a1 is set to the commercial system, and a parameter value b1 is set to the development system. Similarly, as for other prefixes, values set to parameters to which the prefixes are added are different for each environment.

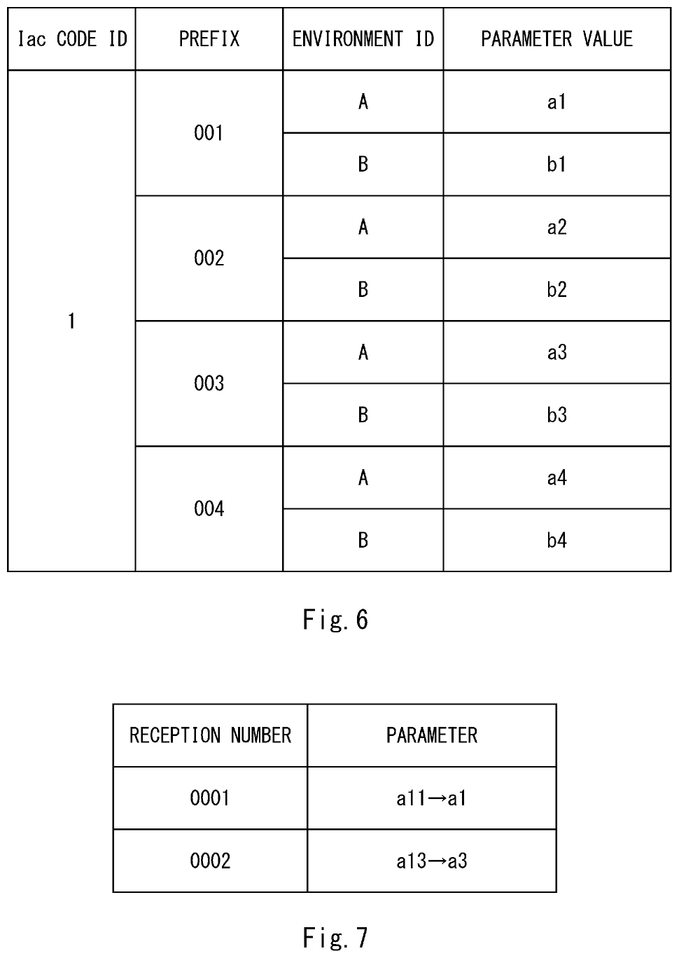

FIG. 7 illustrates a change history database. The change history database manages reception numbers and parameters in association with each other. The reception number is a number issued when the parameter is changed. For example, reception number 0001 indicates that a parameter value_a11 is changed to a parameter value_a1. The parameter value may be changed by a developer or an operator of the IaC code. FIG. 7 may be managed by the management device or may be managed by the CMDB 30.

Returning to FIG. 3, the change unit 21 changes parameters managed in the parameter management database in FIG. 6. A parameter change executed by the change unit 21 is managed in the change history database in FIG. 7. The change unit 21 changes a parameter managed in the parameter management database on the basis of a change instruction input from the developer or the operator, for example. The parameter value before the change and the parameter value after the change may be designated in the change instruction.

When a parameter managed in the parameter management database is changed, the setting unit 22 reflects the changed parameter value in the IaC code. Specifically, the setting unit 22 sets the changed parameter value to the parameter in the IaC code or the configuration file stored in the CMDB 30.

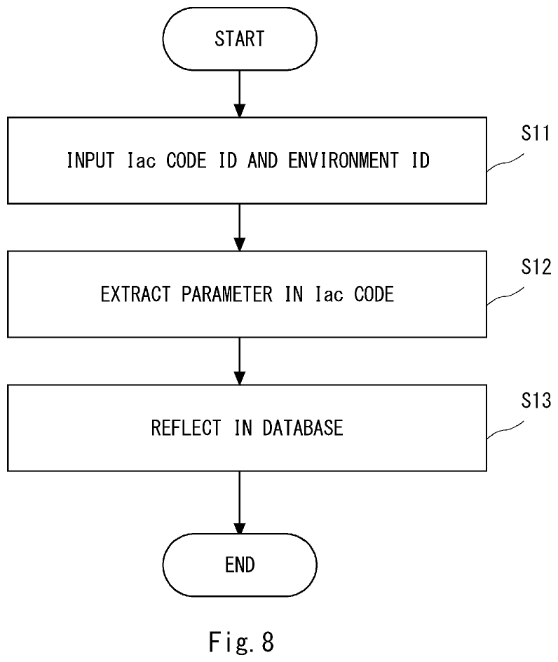

Next, a flow of parameter management processing will be described with reference to FIG. 8. First, the extraction unit 11 inputs the IaC code ID and the environment ID to the CMDB 30 (S11). The extraction unit 11 acquires the environment-specific IaC code from the CMDB 30 by inputting the IaC code ID and the environment ID.

Next, the extraction unit 11 extracts a parameter to which a prefix included in the acquired environment-specific IaC code is added (S12). Next, the management unit 12 reflects the parameter extracted by the extraction unit 11 in the parameter value in the parameter management database illustrated in FIG. 6 (S13). The term reflecting may be replaced with setting, updating, overwriting, or the like. The management unit 12 specifies the parameter value to be reflected in FIG. 6 by using the IaC code ID and the environment ID input by the extraction unit 11 in step S11 and the prefix associated with the parameter extracted in step S12.

The extraction unit 11 acquires different environment-specific IaC codes, extracts a parameter for each environment-specific IaC code, and updates the parameter management database in FIG. 6.

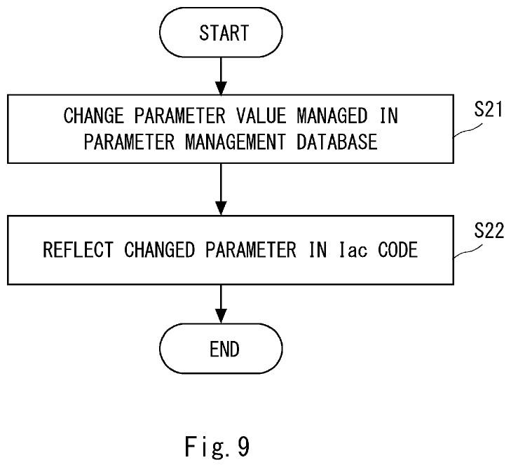

Next, a flow of parameter value change processing will be described with reference to FIG. 9. First, the change unit 21 changes a parameter value managed in the parameter management database (S21). Next, the setting unit 22 reflects the changed parameter value in the IaC code. Specifically, the setting unit 22 sets the changed parameter value to the environment-specific IaC code stored in the CMDB 30.

As described above, the management device 20 according to the second example embodiment can manage the parameters that change in each environment using the database. Accordingly, the developer or the operator who operates the management device 20 can recognize the values of different parameters in each environment by outputting the database to the display unit or the like. That is, when changing a parameter, the developer or the operator does not need to extract the parameter to be changed from the enormous amount of source codes, and can change the value of the parameter set in the parameter management database. As a result, it is possible to efficiently correct or update the IaC code by the developer or the operator.

The management device 20 also manages the changes of the parameter values as history information. Accordingly, if a failure occurs in applying the IaC code to the commercial system 40, for example, the operator can also switch back to the IaC code having the past parameter values.

Although FIGS. 2 and 3 illustrate an example in which the CMDB 30 exists outside the management device 20, the management device 20 and the CMDB 30 may be treated as the same device. That is, the CMDB 30 may be included in the management device 20.

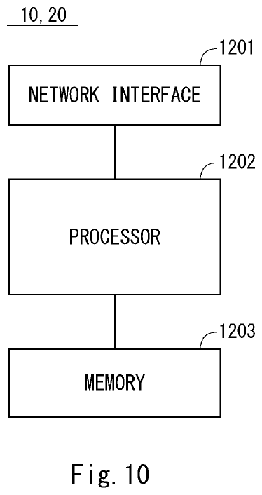

FIG. 10 is a block diagram illustrating a configuration example of the management device 10 and the management device 20 (hereinafter referred to as the management device 10 or the like.). Referring to FIG. 10, the management device 10 or the like includes a network interface 1201, a processor 1202, and a memory 1203. The network interface 1201 may be used to communicate with other network nodes. The network interface 1201 may include, for example, a network interface card (NIC) conforming to IEEE 802.3 series.

The processor 1202 reads and executes software (computer program) from the memory 1203 to perform processing of the management device 10 or the like described with reference to the flowcharts in the above-described example embodiments. The processor 1202 may be, for example, a microprocessor, a micro processing unit (MPU), or a central processing unit (CPU). The processor 1202 may include a plurality of processors.

The memory 1203 is constituted by a combination of a volatile memory and a nonvolatile memory. The memory 1203 may include a storage disposed away from the processor 1202. In this case, the processor 1202 may access the memory 1203 through an input/output (I/O) interface (not shown).

In the example of FIG. 10, the memory 1203 is used to store a software module group. The processor 1202 can perform the processing in the management device 10 or the like described in the above-described example embodiments by reading and executing these software module groups from the memory 1203.

As described with reference to FIG. 10, each of the processors included in the management device 10 or the like in the above-described example embodiments executes one or more programs including a command group for causing a computer to perform the algorithm described with reference to the drawings.

In the above-described example, the program can be stored using various types of non-transitory computer-readable media to be supplied to a computer. The non-transitory computer-readable media include various types of tangible storage media. Examples of the non-transitory computer-readable medium include a magnetic recording medium (for example, a flexible disk, a magnetic tape, or a hard disk drive), an optical magnetic recording medium (for example, a magneto-optical disk), a compact disc-read only memory (CD-ROM), a CD-R, a CD-R/W, and a semiconductor memory (for example, a mask ROM, a programmable ROM (PROM), an erasable PROM (EPROM), a flash ROM, or a random access memory (RAM). The program may be supplied to the computer by various types of transitory computer-readable media. Examples of the transitory computer-readable media include electrical signals, optical signals, and electromagnetic waves. The transitory computer-readable medium can provide the program to the computer via a wired communication line such as an electric wire and optical fibers or a wireless communication line.

Note that the present disclosure is not limited to the above-described example embodiments, and can be appropriately modified without departing from the gist.

Some or all of the above-described example embodiments may be described as in the following Supplementary Notes, but are not limited to the following Supplementary Notes.

(Supplementary Note 1)

A management device including:
an extraction unit that extracts a parameter associated with definition information included in configuration information used for constructing an infrastructure system on a cloud infrastructure; and
a management unit that manages, when the configuration information is applied to a plurality of the infrastructure systems, the parameter to be changed according to the infrastructure system in association with the infrastructure system to which the configuration information is applied.

(Supplementary Note 2)

The management device according to Supplementary Note 1, wherein the configuration information is a source code, and the definition information is information added to the parameter.

(Supplementary Note 3)

The management device according to Supplementary Note 1 or 2, wherein the plurality of infrastructure systems includes a first infrastructure system to which the configuration information is applied; and a second infrastructure system simulating the first infrastructure system.

(Supplementary Note 4)

The management device according to Supplementary Note 3, wherein the second infrastructure system is a development system for developing the first infrastructure system, and uses less resources than the first infrastructure system.

(Supplementary Note 5)

The management device according to any one of Supplementary Notes 1 to 4, wherein the configuration information is a declarative infrastructure as code (IaC).

(Supplementary Note 6)

The management device according to any one of Supplementary Notes 1 to 5, further including:
a change unit that changes a value of the managed parameter; and
a setting unit that sets the changed parameter to the configuration information.

(Supplementary Note 7)

The management device according to Supplementary Note 6, wherein
the changing unit manages a change history of the value of the parameter, and
after reflecting the changed parameter in the configuration information, the setting unit switches back to the parameter before the change based on the change history.

(Supplementary Note 8)

A communication system including:
a management device including an extraction unit that extracts a parameter associated with definition information included in configuration information used for constructing an infrastructure system on a cloud infrastructure, and a management unit that manages, when the configuration information is applied to a plurality of the infrastructure systems, the parameter to be changed according to the infrastructure system in association with the infrastructure system to which the configuration information is applied; and
a database that manages the configuration information.

(Supplementary Note 9)

The communication system according to Supplementary Note 8, wherein the configuration information is a source code, and the definition information is information added to the parameter.

(Supplementary Note 10)

A management method including:
extracting a parameter associated with definition information included in configuration information used for constructing an infrastructure system on a cloud infrastructure; and
managing, when the configuration information is applied to a plurality of the infrastructure systems, the parameter to be changed according to the infrastructure system in association with the infrastructure system to which the configuration information is applied.

(Supplementary Note 11)

A program for causing a computer to perform:
extracting a parameter associated with definition information included in configuration information used for constructing an infrastructure system on a cloud infrastructure; and
managing, when the configuration information is applied to a plurality of the infrastructure systems, the parameter to be changed according to the infrastructure system in association with the infrastructure system to which the configuration information is applied.

Although the invention of the present application has been described above with reference to the example embodiments, the invention of the present application is not limited to the above. Various modifications that can be understood by those skilled in the art can be made to the configuration and details of the invention of the present application within the scope of the invention.

This application claims priority based on Japanese Patent Application No. 2021-045744 filed on Mar. 19, 2021, the entire disclosure of which is incorporated herein.

### REFERENCE SIGNS LIST

10 MANAGEMENT DEVICE
11 EXTRACTION UNIT
12 MANAGEMENT UNIT
20 MANAGEMENT DEVICE
21 CHANGE UNIT
22 SETTING UNIT
30 CMDB
40 COMMERCIAL SYSTEM
42 DEVELOPMENT SYSTEM
50 CLOUD PROVIDER

What is claimed is:

1. A management device comprising:
at least one memory storing instructions, and
at least one processor configured to execute the instructions to;
extract a parameter associated with definition information included in configuration information used for constructing an infrastructure system on a cloud infrastructure; and
manage, when the configuration information is applied to a plurality of the infrastructure systems, the parameter to be changed according to the infrastructure system in association with the infrastructure system to which the configuration information is applied.

2. The management device according to claim 1, wherein the configuration information is a source code, and the definition information is information added to the parameter.

3. The management device according to claim 1, wherein the plurality of infrastructure systems includes a first infrastructure system to which the configuration information is applied; and a second infrastructure system simulating the first infrastructure system.

4. The management device according to claim 3, wherein the second infrastructure system is a development system for developing the first infrastructure system, and uses less resources than the first infrastructure system.

5. The management device according to claim 1, wherein the configuration information is a declarative infrastructure as code (IaC).

6. The management device according to claim 1, wherein the at least one processor is further configured to execute the instructions to:
change a value of the managed parameter; and
set the changed parameter to the configuration information.

7. The management device according to claim 6, wherein the at least one processor is further configured to execute the instructions to:
manage a change history of the value of the parameter, and
after reflecting the changed parameter in the configuration information, switch back to the parameter before the change based on the change history.

8.-9. (canceled)

10. A management method comprising:
extracting a parameter associated with definition information included in configuration information used for constructing an infrastructure system on a cloud infrastructure; and
managing, when the configuration information is applied to a plurality of the infrastructure systems, the parameter to be changed according to the infrastructure system in association with the infrastructure system to which the configuration information is applied.

11. A non-transitory computer-readable medium storing a program for causing a computer to perform:
extracting a parameter associated with definition information included in configuration information used for constructing an infrastructure system on a cloud infrastructure; and
managing, when the configuration information is applied to a plurality of the infrastructure systems, the parameter to be changed according to the infrastructure system in association with the infrastructure system to which the configuration information is applied.
